(19) United States
(12) Patent Application Publication
(10) Pub. No.: US 2006/0082832 A1
(43) Pub. Date: Apr. 20, 2006

(54) Image processing device and image processing program

(75) Inventors: Hirokazu Shoda, Yokohama-shi (JP); Jun Sakakibara, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/968,034

(22) Filed: Oct. 20, 2004

(51) Int. Cl. H04N 1/409

(52) U.S. Cl. 358/3.26

(57) ABSTRACT

The present invention provides a technology by which a high quality monochromatic image without any picture quality deterioration can be obtained from a color image original. An image processing apparatus according to the present invention, comprising: a hue information acquiring portion adapted for acquiring hue information regarding pixels forming an image; a concentration information acquiring portion adapted for acquiring hue concentration information regarding pixels forming the image; and a deterioration determining portion, wherein, in the event that a rate of the number of pixels having the same hue and color concentration as those of pixels forming the image is higher than a predetermined threshold value based on the hue information and the hue concentration information thus acquired, the deterioration determining portion is adapted for determining the possibility of occurrence of picture quality deterioration to be high when the image is transformed into a monochromatic image.

### BACKGROUND OF THE INVENTION

1. Field of the Invention

The present invention relates to an image processing device (apparatus) and an image processing program.

2. Description of the Related Art

In a traditional art, a CCD line sensor for use in a reduction optical system is commonly known in that there are two sensor types, one composed of a single-column CCD line sensor and another composed of plural CCD line sensors arrayed in three columns (three-column CCD line sensor), each CCD line-senor having one of color filters: Red (R), Green (G) and Blue (B) arranged thereon.

The sensor composed of the single-column CCD line sensor is in principle used for reading a monochromatic original. When a color original is read by using such three-column CCD line sensor, a reading method using three light sources each having a spectral characteristic of one of R, G, and B is employed by sequentially turning on the three light sources to read color image information of the color original such that the color information is divided into three color (R, G, B) information. Also, there is proposed another reading method using a light source of while color as a spectral characteristic where at least one of three color filters (R, G, B) can be disposed in an optical path between the light source and the three-column CCD line sensor so as to be switchable from one of the three color filters to another and then divide the white light into three color information incident into the three-column CCD line sensor.

The three-column CCD line sensor as described above is essentially employed for reading a color original, together with a light source, in this case, having a specific spectral characteristic which is enough to cover the visible light range from 400 nm to 700 nm and color filters being disposed on the front sides of respective CCD line sensors to obtain divided color information of R, G, B.

On the other, when the monochromatic original is read by using this three-column CCD line sensor, two approaches have been proposed. A first approach is to use an output from one of three CCD line sensors (an output of the CCD line sensor for G is generally used for the purpose of surely reading a vermilion impress). A second approach is to use all of outputs from the three CCD line sensors for producing white/black information therefrom.

In the event that an original is read by a commonly-used monochromatic scanner without any color filters to be disposed on light receiving surfaces of the CCD line sensors, a reflected light from the original is incident on the CCD line sensors, as a result of which it is possible to read luminance variation of the original but impossible to read any color information therefrom. Accordingly, when information of red color is formed on the original having a base surface of blue color, it is impossible to discriminate between blue and red colors commonly having the same reflectance on the original, but it being dependent on the spectral characteristic of the light source, thereby disadvantageously dealing with both of blue and red information as the same signal. Therefore, when the color original is read by the monochromatic scanner, there may be partially or completely lack of information. If a duplicating operation to print the information onto a paper is performed by using signals based on such information, there may be raised a problem where characters and/or images are partially or completely omitted from an image on the paper.

Also, in the event that the color original is read by a three-column CCD line sensor in which three color filters of red (R), Green (G) and Blue (B) are disposed on respective front surfaces of three CCD line sensors so as to perform a monochromatic duplication for obtaining a monochromatic image, the three CCD line sensors may potentially regard any two colors of the color original, depending on colors, as the same color. As a result, the three-column CCD line sensor may capture defective information from the color original.

In general, the scanner is configured to read image information by imaging reflective light from the original on the respective CCD line sensors. Therefore, color information is reproduced by using the additive color process of three primary colors of light. Also, there is proposed a method of artificially producing achromatic color by adding wavelength ranges of red, blue and green of color filters on the CCD line sensors. In this case, the chromatic information is obtained from the following equation.
The chromatic information=(Red information+Blue information+Green information)/3

However, according to this processing, when characters of red color are formed on an original having a base surface of blue color, the three CCD line sensors will output as (red:blue:green)=(0:255:0) upon reading of the blue base surface information while they will output as (red:blue:green)=(255:0:0) upon reading of the red character information, as a result of which: the blue base information can be monochromatized as (0+255+0)/3=85; and also the red character information can be monochromatized as (255+0+0)/3=85. Therefore, it can be understood that the monochromatic duplication of the color original as mentioned above will generate the same information, i.e., the same color, relative to the blue information and the red information.

In this manner, even if two information are different in balance (chroma) between read, blue and green, one (color) information may be the same additive result of red, blue and green, as that of another (color) information. These information can be regarded as the same signals for the monochromatic duplication. Then, when this color original is monochromatically duplicated, there is caused a problem where characters and/or images may be partially or completely omitted from the paper.

Thus, it is impossible in the traditional art to detect an occurrence of lack of an image and then to awkwardly output such an image intact, thereby outputting a futile duplicated image.

### SUMMARY OF THE INVENTION

In order to overcome these problems as described above, an object of the present invention is to provide a technique for obtaining a high quality monochromatic image without any picture quality deterioration from a color image original.

In view of the above-mentioned problems, an image processing apparatus according to the present invention, comprising: a hue information acquiring portion adapted for acquiring hue information regarding pixels forming an image; a concentration information acquiring portion adapted for acquiring hue concentration information regarding pixels forming the image; and a deterioration determining portion, wherein, in the event that a rate of the number of pixels having the same hue and color concentration as those of pixels forming the image is higher than a predetermined threshold value based on the hue information and the hue concentration information thus acquired, said deterioration determining portion is adapted for determining the possibility of occurrence of picture quality deterioration to be high when the image is transformed into a monochromatic image.

Also, another image processing apparatus according to the present invention, comprising: a hue information acquiring portion adapted for acquiring hue information regarding pixels forming an image; a concentration information acquiring portion adapted for acquiring hue concentration information regarding pixels forming the image; based on the hue information and the hue concentration information thus acquired, a histogram calculating portion adapted for calculating a histogram representative of a relation between a color concentration for each hue and the number of pixels having said color concentration; and a deterioration determining portion, wherein, in the event that a rate at which histograms calculated for hues by said histogram calculating portion are overlapped one another is higher than a predetermined threshold value based on the hue information and the hue concentration information thus acquired, said deterioration determining portion is adapted for determining the possibility of occurrence of picture quality deterioration to be high when the image is transformed into a monochromatic image.

In view of the above-mentioned problems, an image processing program according to the present invention is allowed to be executed by a computer and comprises the steps of: acquiring hue information regarding pixels forming an image; acquiring hue concentration information regarding pixels forming the image; and in the event that a rate of the number of pixels having the same hue and color concentration as those of pixels forming the image is higher than a predetermined threshold value based on the hue information and the hue concentration information thus acquired, determining the possibility of occurrence of picture quality deterioration to be high when the image is transformed into a monochromatic image.

Also, An image processing program according to the present invention is allowed to be executed by a computer and comprises the steps of: acquiring hue information regarding pixels forming an image; acquiring hue concentration information regarding pixels forming the image; based on the hue information and the hue concentration information thus acquired, calculating a histogram representative of a relation between a color concentration for each hue and the number of pixels having said color concentration; and in the event that a rate at which histograms calculated for hues by said histogram calculation step are overlapped one another is higher than a predetermined threshold value, determining the possibility of occurrence of picture quality deterioration to be high when the image is transformed into a monochromatic image.

### BRIEF DESCRIPTION OF THE DRAWINGS

FIG. 1 is a side sectional view showing an image reading apparatus utilizing four CCD line sensors according to a first embodiment of the present invention;

FIG. 2 is a schematic diagram illustrating four CCD line sensors;

FIG. 3 is a schematic diagram illustrating drive timings and output signals of the CCD line sensors;

FIG. 4 is a schematic diagram illustrating four CCD line sensors different from those of FIG. 2;

FIG. 5(A) is a block diagram illustrating an analog processing operation for processing a signal outputted from the CCD line sensor;

FIG. 5(B) is a block diagram illustrating an analog processing operation for processing a signal outputted from the CCD line sensor;

FIG. 6 is a block diagram illustrating a control circuit system relative to the CCD line sensor;

FIG. 7 (A) is a schematic diagram showing a digital copying machine comprising an image reading apparatus and a scanner portion adapted for forming an image on a paper;

FIG. 7 (B) is a schematic diagram showing a digital copying machine comprising an image reading apparatus and a scanner portion adapted for forming an image on a paper;

FIG. 8 is a conceptional view showing a copying machine comprising a image reading apparatus 60 and an image forming apparatus 70;

FIG. 9 is a schematic diagram illustrating a detailed configuration of an image processing portion;

FIG. 10 is a block diagram illustrating a detailed configuration of a discriminating portion;

FIG. 11 is a schematic diagram illustrating a 3×3 filter matrix for an edge detection;

FIG. 12 a schematic diagram illustrating the result of a character region determination;

FIG. 13 is a schematic diagram illustrating a conception of a hue signal;

FIG. 14 is a schematic diagram illustrating a sampling region in a sample extracting portion;

FIG. 15 is a schematic diagram illustrating a signal output in a color character determining portion;

FIG. 16 is a schematic diagram illustrating a configuration of a picture quality deterioration determination portion 216;

FIG. 17 is an example of histograms in base concentration;

FIG. 18 is a flow chart for illustrating an operation flow from a scan start to an image output;

FIG. 19 is a schematic diagram illustrating a detailed configuration of an image processing portion;

FIG. 20 is a flowchart illustrating an overall processing flow of the image processing apparatus;

FIG. 21(A) is a specific example illustrating advantageous effects achieved upon duplication; and

FIG. 21(B) is a specific example illustrating advantageous effects achieved upon duplication.

### DESCRIPTION OF THE PREFERRED EMBODIMENTS

Hereinafter, embodiments according to the present invention will be described in detail with reference to the accompanying drawings.

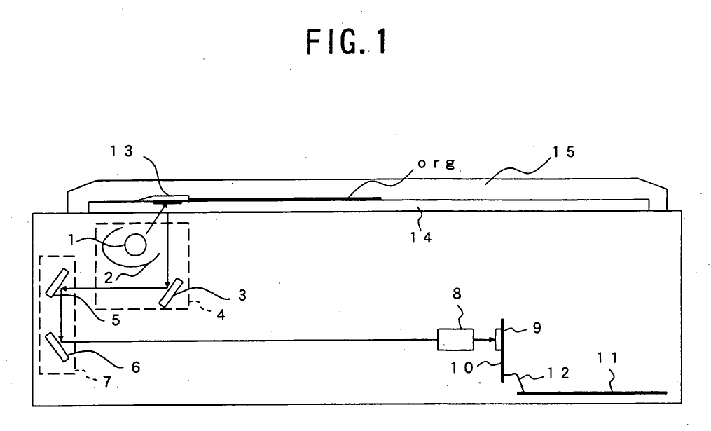

FIGS. 1 is a side sectional view showing an image reading apparatus (corresponding to an image processing apparatus) utilizing four CCD line sensors (hereinafter, it is referred to as a “CCD line sensor”) according a first embodiment of the present invention.

In this image reading apparatus, an original ORG is placed on the document glass 14 in a face down fashion and then forced onto the document glass 14 by closing a original-impressing cover 15 which is openably set for fixing the original ORG on the document glass 14.

The original ORG is irradiated by a light source 1 to image its reflective light via a first mirror 3, a second mirror 5, a third mirror 6 and a condenser lens 8 on a front side of the CCD line sensor 9 implemented on a CCD sensor substrate 10. A non-shown carriage driving motor(s) moves a first carriage 4 containing therein the light source 1 and the first mirror 3 and a second carriage 7 containing therein the second and third mirrors 5 and 6 so that the original ORG is scanned with the irradiation from the light source 1. A moving speed of the first carriage 4 is set twice as fast as that of the second carriage 7 so that the length of an optical path between the document glass 14 and the CCD line sensor 9 can be controlled to remain constant.

Thus, the original ORG placed on the document glass 14 is sequentially read one-line by one-line and an optical signal of its reflective light is converted into an analog signal depending on the intensity of the reflective light by the CCD line sensor 9. Subsequently, the converted analog signal is converted into digital signal which then is passed via a harness 12 into a control substrate 11 adapted for handling control signals in association with CCD sensors. In this control substrate 11, a digital signal processing operation is executed in such a manner that a subharmonic distortion due to the condenser lens 8 and/or a harmonic distortion due to sensitivity dispersion of the CCD line sensor (corresponding to an image reading portion as described later on) can be corrected by a digital signal processing operation such as a shading (distortion) correction method and the like.

It should be noted that the processing operation for converting the analog signal into the digital signal can be executed by the CCD sensor substrate 10 or by the control substrate 11 via the harness 12.

When the shading correction is executed, a reference signal for black and a reference signal for white are required. Specifically, the former black reference signal is set as an output signal from the CCD line sensor 9 on condition that any light is not irradiated onto the CCD line sensor 9 when the light source 1 is extinguished. The latter white reference signal is set as an output signal from the CCD line sensor 9 upon reading of a white reference plate 13 on condition that the light source 1 is lighted. Also, it is a general practice to average signals resulting from reading plural lines in order to reduce adverse influences due to singular point and/or quantization error.

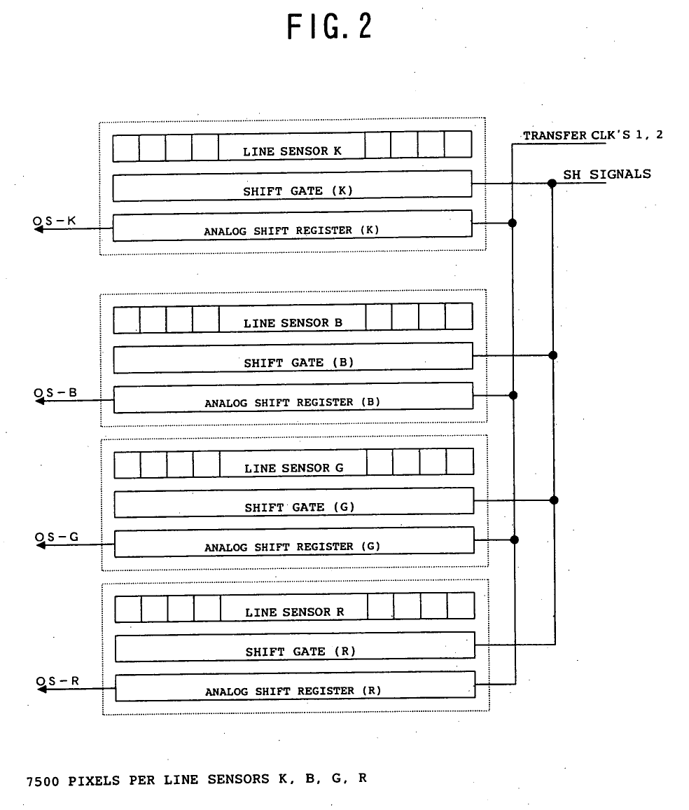

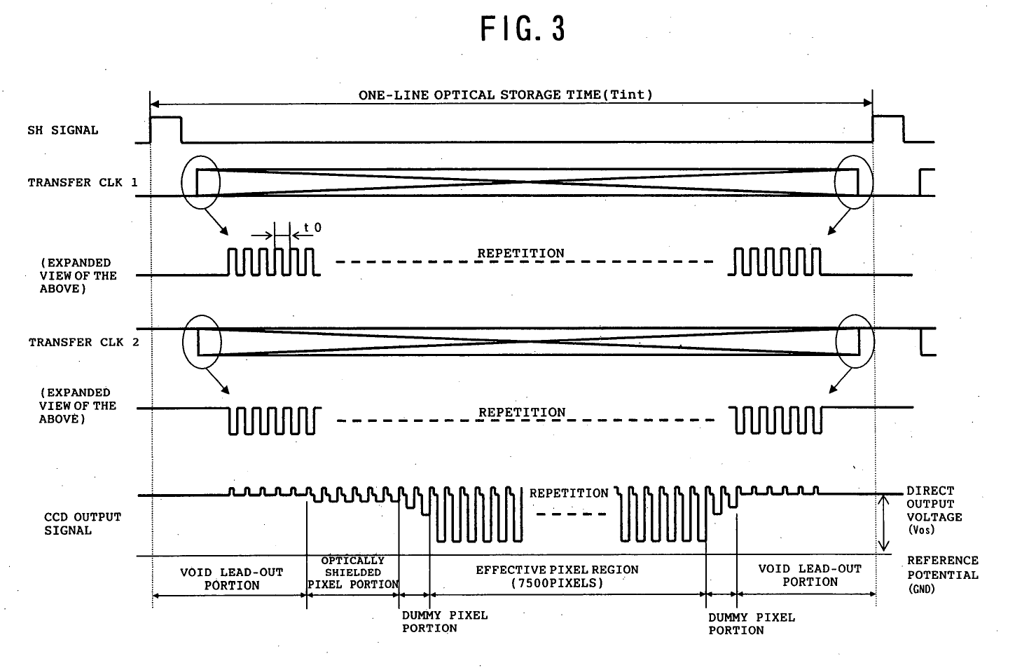

In the following, a configuration and operation of the CCD line sensor 9 will be described with reference to FIGS. 2 and 3.

FIG. 2 shows a four-CCD line sensor example according to an embodiment of the present invention and comprised of a line sensor K having no color filter disposed on its light receiving surface and three line sensors (i.e., a line sensor B, a line sensor G and a line sensor R) having blue (B), green (G) and red (R) color filters on their light receiving surfaces, respectively. These line sensors K, B, G, R are each composed of a photodiode array adapted for executing a photo-electro conversion.

In the event that a sheet of the original ORG is of size A4 for example, the original ORG has an area of 297 mm in longitudinal direction and 210 mm in transverse direction. When the original reading operation is executed in a main scanning direction as the longitudinal direction and in a sub scanning direction as the transverse direction, the photodiode array of the CCD line sensor 9 requires at least 7016 pixels as the number of effective pixels (4677 pixels at the time of 400 dpi). In general, a number of sensors are used to afford 75000 pixels (5000 pixels at the time of 400 dpi).

Also, as shown in 3, the CCD line sensor comprises an optically shielded pixel portion at which the photodiode array is partially shielded with aluminum or the like to prevent any light from being incident thereto and which is anterior to the effective 7500 pixels, dummy pixel portions which are located respectively before and after the effective 7500 pixels, and void lead-out portions which are located respectively before and after the effective 7500 pixels. Thus, in order to outwardly output all of electrical charges stored in the CCD line sensor, the required number of transfer CLK's is more than 7500 pixels.

On the assumption that the total number of the optically shielded, void lead-out and dummy pixel portions with the exception of the effective pixel region is 500 pulses in terms of the number of the transfer CLK's, 8000 pulses as a time period of the transfer CLK's are required for outwardly outputting all of charges stored only in one-line (or one-column) of the CCD line sensor. This corresponds to a one-line optical storage time (tINT).

The CCD line sensor is characterized by its output signal which is outputted under the reference of voltage level donning a certain offset with respect to an electrical reference level (reference potential: GND). This voltage level as the reference is referred to as a “direct output voltage (offset level: Vos).

During a low “L” level of a SH signal in the one-line optical storage time (iINT) as shown in FIG. 3, an optical energy irradiated on a CCD line sensor is stored as charges in photodiodes. Then, during a high “H” level of the SH signal, the stored charges are passed through a shift gate adjacent to the photodiodes and transferred to an analog shift register adjacent to the shift gate. After this transfer operation has been completed, the SH signal is turned to its “L” level to operate the shift gate so as to prevent any charges from being leaked out of the photodiodes and restart a charge storing operation at the photodiodes.

The charges transferred to the analog shift register are transferred outwardly by a pixel unit and at a period of the transfer CLK's. Due to this movement, an application of the transfer CLK's is stopped for a time period during which charges are shifted from the photodiodes to the analog shift register via the shift gate by means of the SH signal (see FIG. 3).

Also, in the event that the transfer CLK is normally inputted and that the transfer CLK is stopped in accordance with the SH signal in the interior of the CCD line sensor, the internal charge transfer movement is similar to that as above. In particular, depending on the CCD line sensor, the SH signal and the transfer CLK may be different in their polarities from those as shown in FIG. 3 but internal operations of the CCD line sensor are similar to those as shown in FIG. 3. The time period expended for the transfer CLK's of 8000 pulses does not mean, regardless of a stoppage state of the transfer CLK in accordance with the SH signal, the number of CLK's but the time.

For example, on the assumption that an image transfer frequency of a four-line CCD line sensor 6 is f=20 MHz, a time period of 8000 (CLK's)×( 1/20 MHz)=400 μs is expended for outwardly outputting all of charges stored in each line of the four-line CCD line sensor. This time period corresponds to the one-line optical storage time expended for one line in the sub scanning direction of the four-line CCD line sensor.

Hereinafter, an analog signal amplitude outputted from the four-line CCD line sensor 9 will be explained on the condition that the transfer CLKt0: 20 MHz and the one-line optical storage time tINT=400 μs. However, depending on a product specification, there may arise a case which is different in transfer CLK frequency from those as above.

Incidentally, the four-line CCD line sensor is, as described above, comprised of: the line sensor BK having no color filter disposed on its light receiving surface and the three line sensors R, G, B each being a color filter disposed on its light receiving surface. When these line sensors are uniformly irradiated by a light from the light source, the line sensor BK can output an analog signal that is larger in amplitude than that which can be outputted from each of the line sensors R, G, B because each of the line sensors R, G, B has a sensitivity only in a specific wavelength range but the line sensor BK has a sensitivity in a wide wavelength range from less than 400 nm to more than 1000 nm.

In addition, only the line sensor BK adopts a two-system output type by which the stored charges therein are separated into odd-pixels and even-pixels, thereby enabling a speed for reading a monochromatic original or the like by the line sensor BK to be increased. This case is similar in performance to that of a single-system output type as shown in FIG. 3, particularly with respect to output signals, the void lead-out portion, the optically shielded, the dummy pixel portion and the effective pixel region. Further, the line sensor of the two-system output type requires a half of the number of the transfer CLK's expended for transferring all of pixels therein as compared with that of the single-system output type. For example, 7500 of the CLK's are required for transferring all of pixles from the effective pixel region in the case of the single-system output type while, in the two-system output type, only 3750 of the CLK's, i.e., a half of 7500 CLK's, are required. Therefore, it is possible in the two-system output type to shorten the one-line optical storage time of the SH signal as shown in FIG. 3.

Correspondingly, if the number (7500) of the effective pixels of each photodiode set for the line sensors R, G, B having color filters disposed on their light receiving surfaces is reduced to a half of 7500 (3750) and each pixel size is doubled, it is possible to equalize a reading coverage of each of the line sensor R, G, B relative to the line sensor BK. Because there is a large difference in sensitivity whether or not the color filter is disposed on the light receiving surface of the liner-sensor, it is possible to enhance the sensitivity of the line sensor having the color filter disposed on its light receiving surface by enlarging an area for pixels of the liner-sensor.

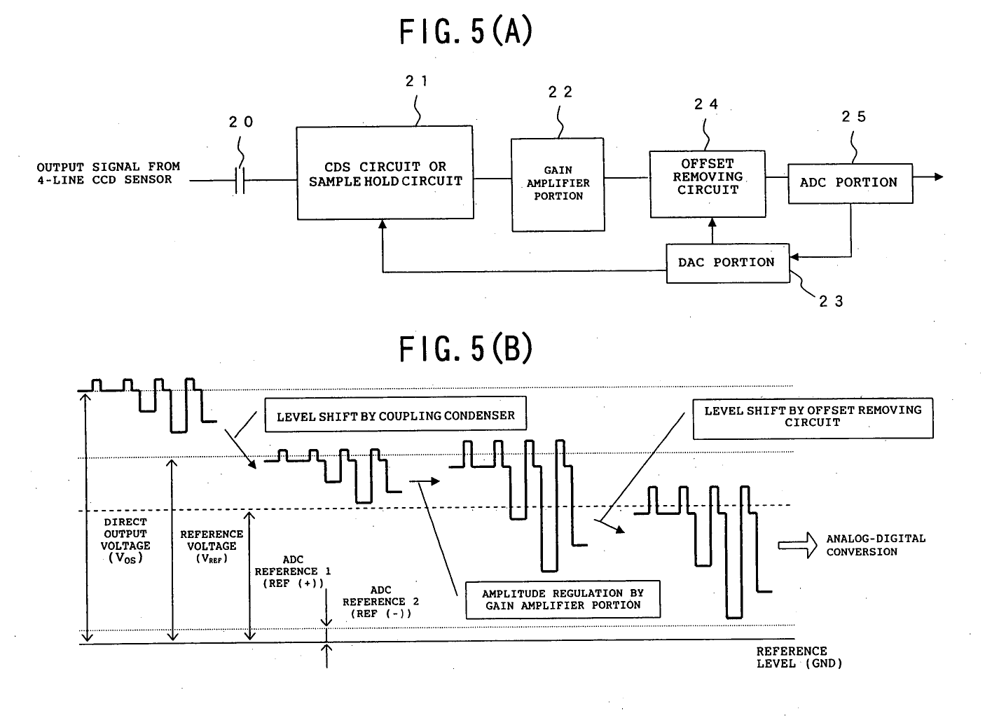

FIG. 5(A) is a block diagram showing an analog processing circuit for processing an analog signal outputted from the CCD line sensor. FIG. 5(B) is an illustrative diagram showing an analog waveform to be processed by the analog processing circuit.

As shown in FIG. 5(A), the analog processing circuit for processing analog signals outputted from the CCD line sensor 9 is generally comprised of: a coupling condenser 20; a correlative double sampling circuit (CDS) or sample hold circuit 21; a gain amplifier portion 22; a digital analog converter (DAC) 23; an offset removing circuit 24 for removing a direct component; and an analog digital converter (ADC) portion 25.

Operations of the above will be described with reference to FIG. 5(B).

Output signals from the CCD line sensor are each outputted as the reference of a direct output voltage (Vos) also as shown in FIG. 3. This direct output voltage (Vos) are different depending on a CCD line sensor as used. In the case of a CCD line sensor employing a voltage source of +12 volts, its output has a dispersion of about 3-8 volts. The coupling condenser 20 is coupled in series thereto for the purpose of removing a direct component of a signal having an uncertain level.

At this time, a potential of the dummy pixel portion or the optically shielded pixel portion is processed to be adjusted within a reference potential (Vref) in order to facilitate the processing in the CDS circuit or sample hold circuit 21.

Then, an analog signal which has been outputted from the CCD line sensor and whose direct component has been removed in the condenser 20 is processed to be adjusted within an input range of the posterior ADC portion 25. At that time, in order to adjust the direct component within the input range, a direct voltage is generated in the DAC portion 23 and then is regulated in the CDS circuit or sample hold circuit 21 serving as the correlative double sampling circuit and the offset removing circuit 24 so as to conform a voltage of the optically shielded pixel portion of the CCD line sensor with that direct voltage.

As shown in FIG. 5(B), a reference voltage at a “H” level side as required for conversion in the ADC portion 25 is set to an ADC reference 1 (ref (+)) and a reference voltage at a “L” level side thereof is set to an ADC reference 2 (ref(−)) The signal processing is executed to fall within these voltage range. At that time, if a signal which is more than the ADC reference 1 (ref (+)) or less than the ADC reference 2 (ref (−)) is inputted to the ADC portion 25, an output from the ADC portion 25 can be saturated. Therefore, the input into the ADC portion 25 must be within the reference range.

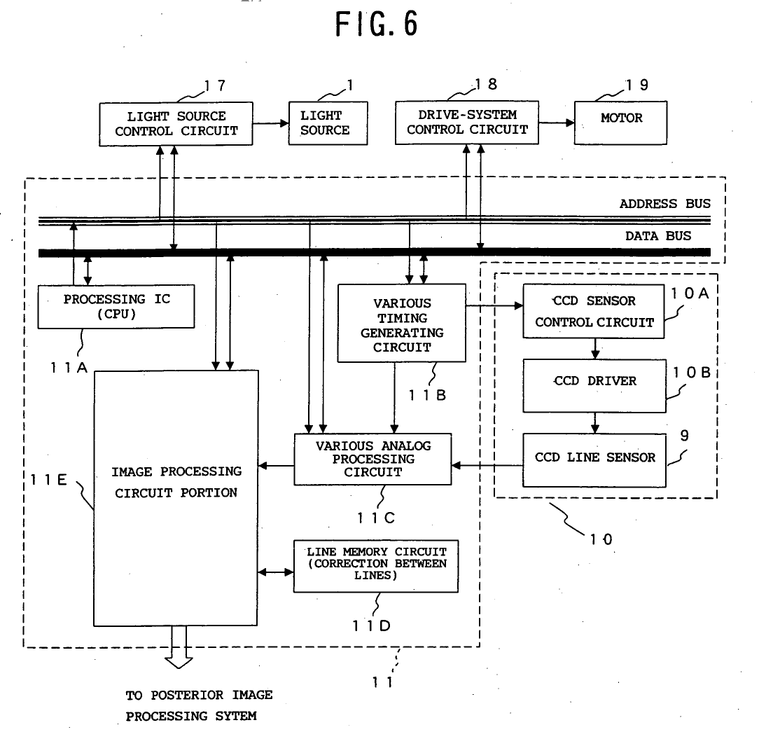

FIG. 6 is a block diagram showing the control substrate 11.

The control substrate 11 is comprised of: a processing IC 11A such as CPU; various timing generating circuits 11B; various analog processing circuits 11C as shown in FIG. 5(A); a line memory circuit 11D; and an image processing circuit portion 11E.

The processing IC 11A is adapted for controlling a signal processing system of the CCD line sensor 9 and additionally controlling a drive-system control circuit 18. By using control signals from an address bus and a data bus, this drive-system control circuit 18 is adapted for controlling a light source control circuit 17 to control the light source 1 and further for controlling a motor 19 to move the first and second carriages 4 and 7.

The various timing generating circuit 11B is adapted for generating: the SH signal and transfer CLK's as shown in FIG. 3; a signal required for driving the CCD line sensor 9; and a signal required for executing various analog processing operations as shown in FIG. 5(B). The signal which has been generated by the various timing generating circuit 11B to drive the CCD line sensor 9 is subjected to a timing regulation in a CCD sensor controlling circuit 10A, or inputted to the CCD line sensor 9 via the CCD driver 10B for adjusting a signal amplitude level or shaping waveform. Incidentally, the CCD line sensor control circuit 10A may be included in the various timing generating circuit 11B.

A output from the CCD line sensor 9 is inputted to the various analog processing circuit 11C to execute a variety of analog processing operations as shown in FIG. 5(B). As shown in FIG. 6, this various analog processing circuit 11C is explained as one of components of the control substrate 11 but may be located on the CCD sensor substrate 10.

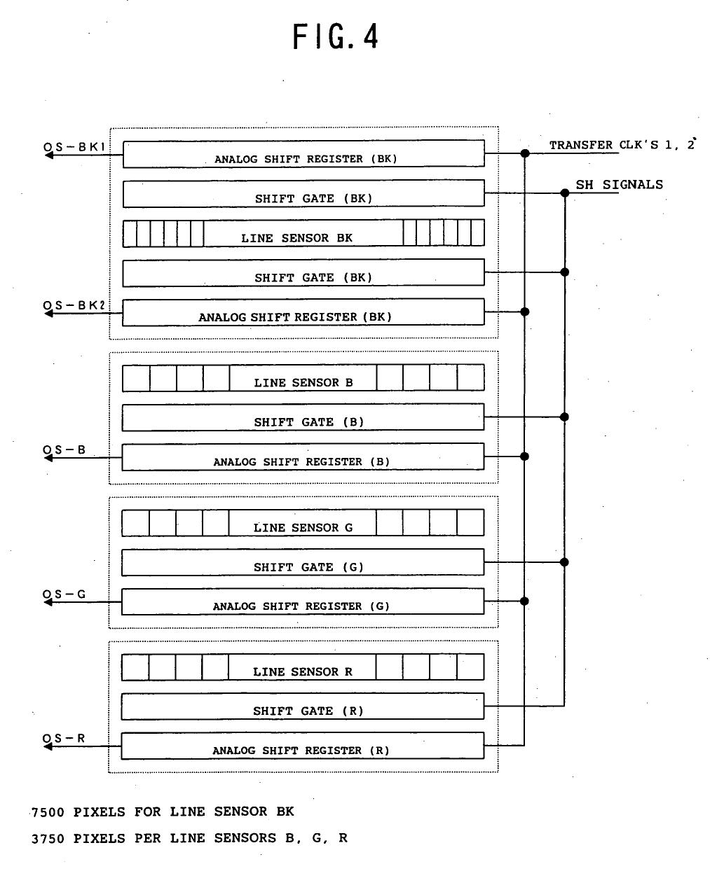

In the structure of the CCD line sensor 9, respective line sensors are physically spaced from each other as shown in FIG. 2 or FIG. 4, as a result of which there can arise any dislocation among their reading positions. The line memory circuit 11D is adapted for correcting such a reading position dislocation.

The image processing circuit portion 11E is adapted for controlling the line memory circuit 11D and further adapted for executing various processing operations of a shading correction, an expansion/reduction processing, a LOG transformation and the like by using digitalized image signals. Also, various processing operations of reading the color original and converting its image into monochromatic signals of achromatic color are executed in this image processing circuit portion 11E. These processing operations will be explained in detail later on.

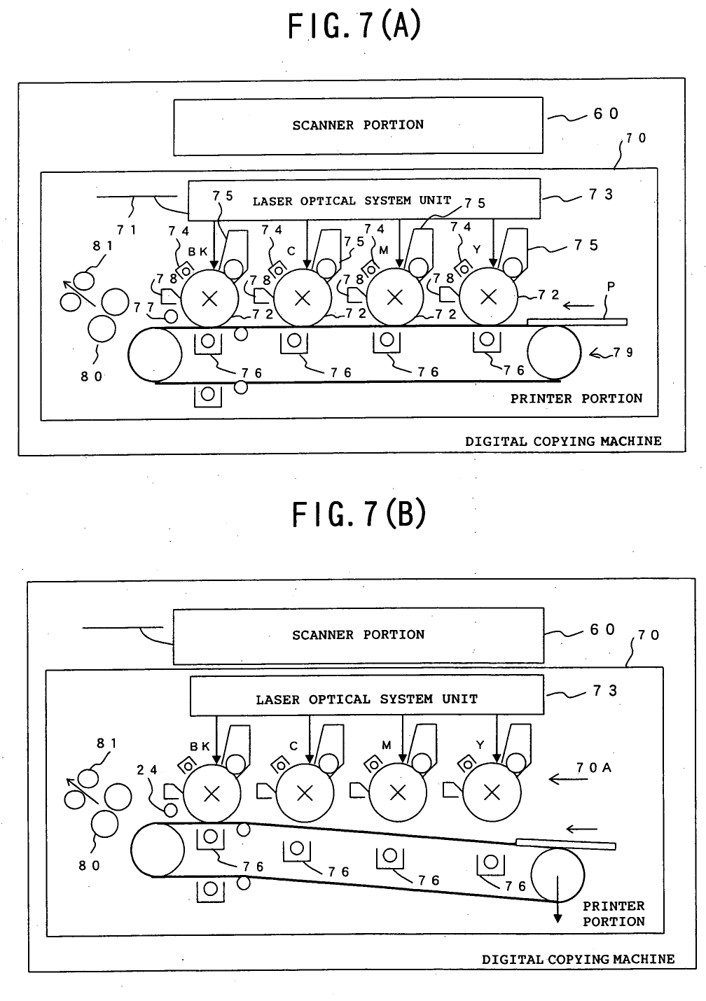

FIGS. 7(A) and 7(B) are schematic diagrams showing a digital copying machine (corresponding to the image processing apparatus) comprising the image reading apparatus (scanner portion 60) and a printer portion 70. This printer portion 70 is an example of image forming apparatuses compatible with full-color image formation. In the same Figures, there are provided developing systems of Y (yellow), M (magenta), C (cyan), K (black) independently from each other. FIG. 7(A) shows an internal state of the digital copying machine for forming a full-color image. FIG. 7(A) shows a state in which a full-color image is formed. When a monochromatic image is formed according to the present invention as shown in FIG. 7(B), only K-developing system is gotten in contact with a print medium sheet to form the image on the print medium sheet while the other Y-, M- and C-developing system are not in contact with the print medium sheet.

In addition, the printer portion (the image forming apparatus) 70 is comprised of: an image processing substrate 71 adapted for executing required processing operations for an image formation, e.g., for converting information read by the CCD line sensor 9 into a control signal for a light emitting element such as a non-shown semiconductor laser; a laser optical system unit 73 on which the light emitting element such as the non-semiconductor laser is mounted for forming a latent image on a photosensitive drum 72; and an image forming portion 70A. This image forming 70A is comprised of: the photosensitive drums 72; electrical chargers 74; developers 75; transfer chargers 76; separation chargers 77; cleaners 78; a sheet transporting mechanism 79 for transporting a sheet P; and fixer 80, which are all required for the image formation by the electrophotographic process.

The print medium sheet P on which an image has already been formed in the image forming portion 70A is discharged into a discharging tray (not shown) by discharging rollers 81 for discharging the print medium sheet P outside of the machine.

Additionally, another example of the image forming apparatuses compatible with full-color image formation may be configured for forming an image on a single photosensitive drum directly by the four Y-, M-, C-, K-developers disposed around the single photosensitive drum. Yet another example of the image forming apparatus compatible with full-color image formation may be configured for temporarily forming an image on an intermediate member by the four Y-, M-, C-, K-developers and then transferring the image onto the photosensitive drum. Further example of the image forming apparatuses compatible with full-color image formation may be configured for temporarily forming an image on an intermediate member by the four Y-, M-, C-, K-developers and then transferring the respective images onto the photosensitive drum.

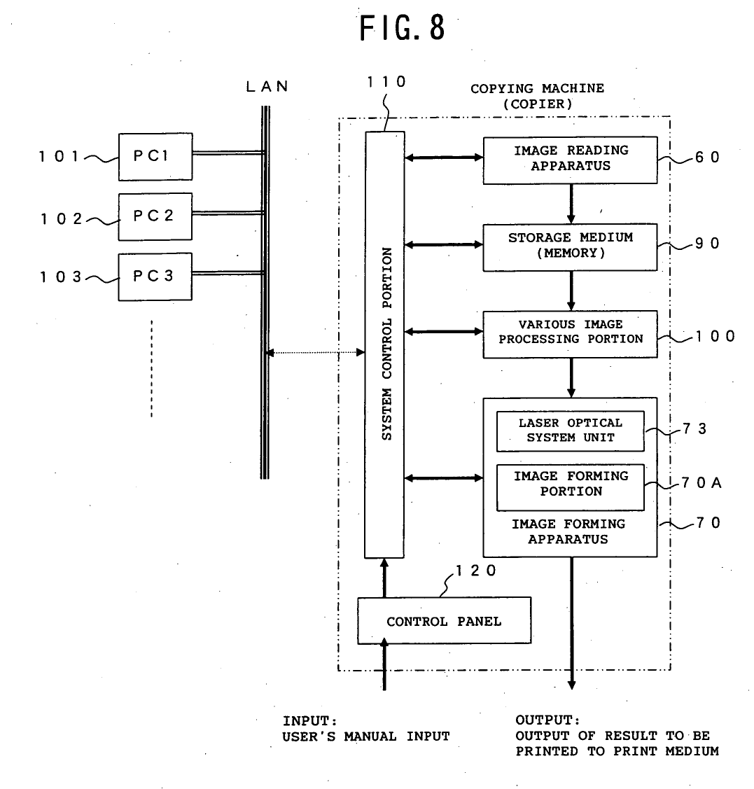

FIG. 8 is a conceptional diagram showing the copying machine comprising the image reading apparatus 60 and the image forming apparatus 70.

This system comprises; the image reading apparatus (scanner portion 60); a memory 90 serving as a storage medium; a various image processing portion 100; and the image forming apparatus (printer portion 70) including therein a laser optical system unit 73 using a semiconductor laser and an image forming portion 70A for forming a toned image by the electrophotographic process, a system control portion 110 for controlling all of the former components and a control panel 120 by which a user directly performs input operations.

In this case, there are provided a singular mode in which this copying machine can be used singularly, a network printer mode in which this copying machine can be used as a network printer from external computers PC101, PC102, PC 103, by connecting itself to a network, and a network scanner mode in which this copying machine can be used as a network scanner from external computers PC101, PC102, PC 103, . . . by connecting itself to a network.

When this copying machine is used in the singular mode, firstly a user places an original ORG to be copied on the image reading apparatus (scanner portion A) and conducts a desired setting on the control panel 120. The control panel 120 comprises (but not illustrated): an auto color button for making the apparatus detect whether the original ORG is a monochromatic or color original; full-color and black buttons for making the user set a kind of the original beforehand; a copy/scanner button for making the user use this apparatus as a copier or as a scanner; a display portion for displaying thereon an expansion/reduction operation and the set number of sheets; a setting portion having number keys 0, 1, 2, . . . 9 for inputting the desired number of sheets to be copied and a clear button for clearing the inputted and set number of sheets; a reset button for initializing the condition which has been set on the control panel; a stop button for stopping a copying operation or scanning operation; and a start button for starting the copying operation or scanning operation.

There is no problem where the control panel 120 is constructed, for example, by a touch panel overlaid on a liquid crystal display (LCD) with various buttons as described above.

The copying operation is started by setting the original ORG, closing the original-impressing cover 15, setting a kind and size of the original and the number of sheets to be copied and then pressing the start button. Hence, an image information read by the scanner portion 60 is temporarily stored in the memory 90 as a storage device. This memory 90 is composed of a page memory having a more capacity than that capable of storing all of image information of the maximum copiable size. The image signal outputted from this memory 90 is subjected to various processing operations such as expansion, equivalent amplification, reduction, and gradation correction in the various image processing portion 100 at a posterior stage to the memory 90, and converted into a control signal for the semiconductor laser to be inputted to the posterior laser optical system unit 73.

In the laser optical system unit 73, an optical output from each semiconductor laser by means of the image signal is irradiated onto the photosensitive drum 72 in the image forming portion 70A. The image forming portion 70A is adapted for forming an image according to the electrophotographic process.

In the network printer mode, the image information is outputted from the external computer(s) by a network connection via the system control portion 110. During this operation, the image information, e.g., outputted from the PC 101 as an external computer, is stored in the memory 90 via the system control portion 110. Then, similarly to that of the copying operation, the image is printed on the print medium of sheet P and outputted outwardly by the image forming portion 70A in the printer portion 70.

In the network scanner mode, the image information read by the scanner portion 60 is outputted as an image into a network connected computer via the system control portion 110.

For example, the user places the original ORG on the scanner portion 60, sets a kind and size of the original and then sets whether this is the copying operation or the scanner operation. Further, the user sets an address of the network connected computer PC 101 as a destination of the image information and presses the start button to start this operation. The image information read by the scanner portion 60 is stored in the memory 90 and then subjected to a desired processing operation for compression such as JPEG or PDF format in the various image processing portion 100 at a posterior stage of the memory 90. The compressed image information is via the system control portion 110 transferred through the network to the external computer PC 101.

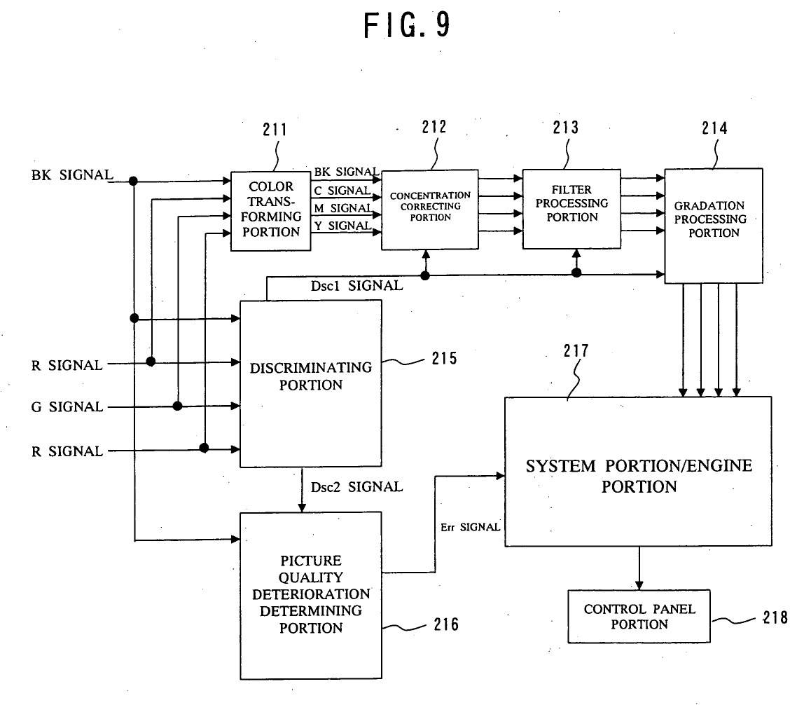

Next, a configuration of the image processing portion according to the embodiment of the present invention (corresponding to hue information acquiring portion and a concentration information acquiring portion) will be described with reference to FIG. 9.

In the above configuration, a color signal (corresponding to hue information) (RGB signals) and a monochromatic signal (corresponding to luminance information) (BK signals) outputted from the scanner portion 60 are acquired by the image processing portion (hue information acquisition step and concentration acquisition step) and inputted to a color transforming portion 211 at which their luminance signals are transformed in concentration (gray-scale) into a Cyan signal, a Magenta signal, a Yellow signal, and a BK signal. C/M/Y/BK signals thus transformed in concentration are inputted to a monochromatic correcting portion 212.

As described in detail later on, a concentration correcting portion 212 selects a concentration correction table based on a discrimination signal Dsc1 from a discriminating portion 215 to correct respective colors in concentration. In the filter processing portion 213, signals outputted from the concentration correcting portion 212 are subjected to LPF (Low Pass Filter) processing operation and HPF (High Pass Filter) processing operation any one of which will be selected based on the Dsc1 outputted from the discriminating portion 215.

Signals outputted from the filter processing portion 213 are subjected to gradation processing operation in the gradation processing portion 214 based on the Dsc1 signal. C/M/Y/BK signals thus subjected to the gradation processing operation are outputted into a system portion/engine portion to print an image. The discriminating portion 215 is adapted for outputting the discrimination signal Dsc1 for discriminating a character region from a non-character region and a discrimination signal Dsc2 for discriminating a character color from a base color.

A picture quality deterioration determining portion (deterioration determining portion) 216 is adapted for predicting an occurrence of image crush based on the RGB signals/BK signal and the discrimination signal Dsc2 and then for outputting a determination signal Err when the occurrence of image crush is predicted. The outputted Err signal is outputted into the system portion/engine portion 217 which notifies a user at display means such as a control panel 218 that the image crush will be occurred.

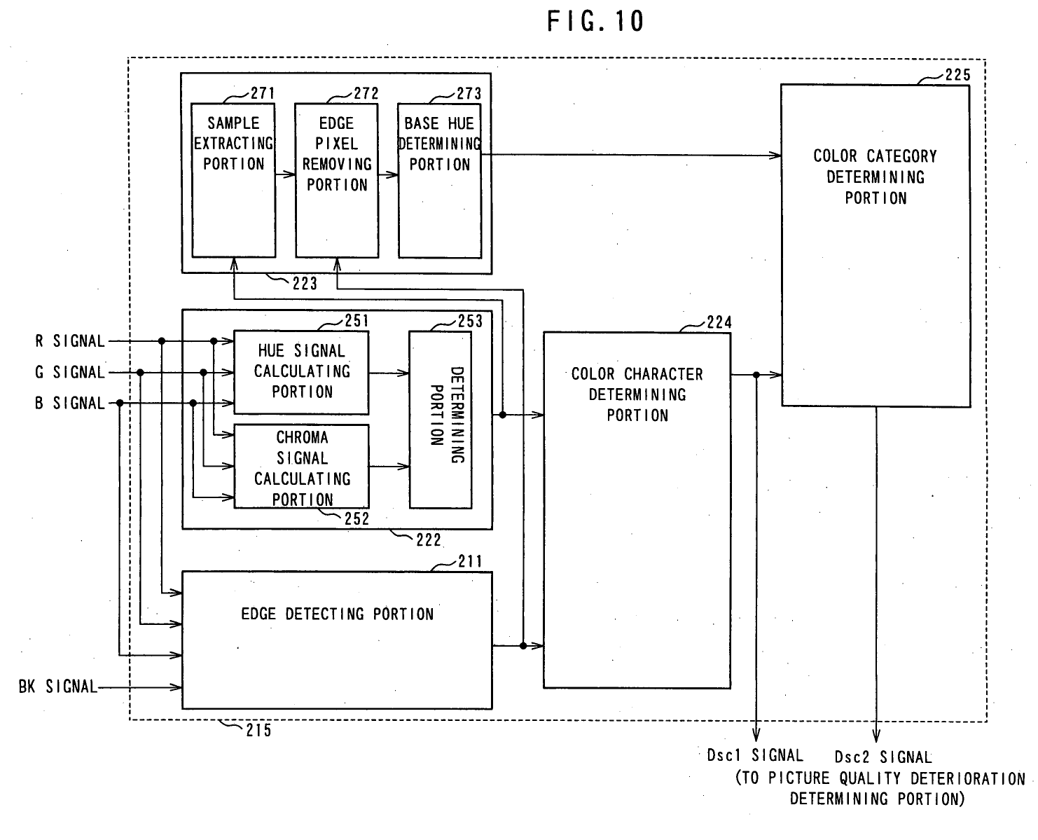

With the above explanation in mind, a configuration of the discriminating portion 215 will be described with reference to FIG. 10. The discrimination porting 215 is comprised: an edge detecting portion (corresponding to a region discriminating portion) 221; a hue determining portion 222; a base color determining portion 223; a color character determining portion 224; and a color category determining portion 225.

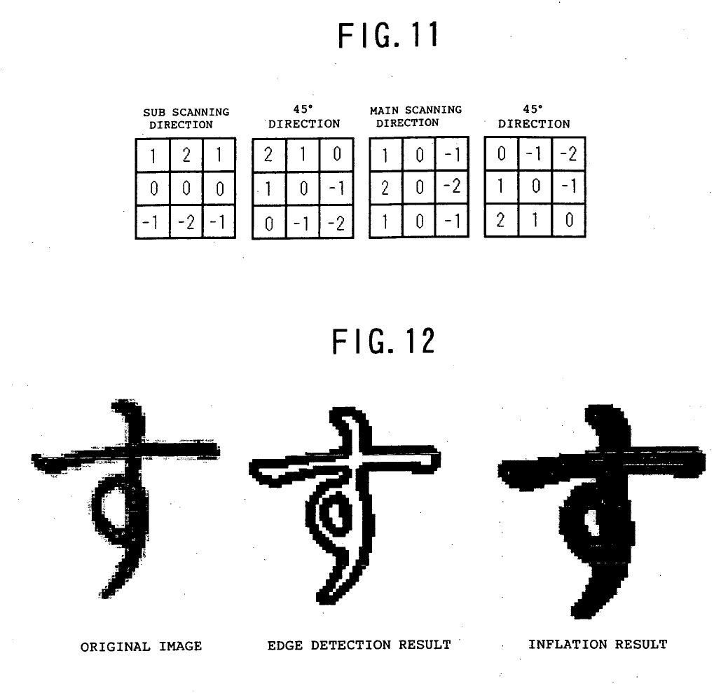

The edge detecting portion 221 is adapted for detecting an edge within the image based on the RGB signals and BK signal as input signals. The edge detecting portion 221 is also adapted for calculating an edge characteristic amount in a vertical direction, in a horizontal and in diagonal directions (two kinds of ±45° directions) by performing 3×3 matrix operation using Sobel filters as shown in FIG. 11. The calculated edge characteristic amount is compared to a threshold value Th to discriminate a character region (corresponding to a specific region) (a region discrimination step).

In general, this threshold value Th can be set to a value suitable for a character discrimination based on the MTF (Modulation Transfer Function) characteristic of the scanner. As shown in FIG. 12, the resultant character region thus discriminated is inflated in the interior of a character so that not only edge portion but also a character region in the interior of the character can be discriminated.

More specifically, the directionality in concentration change with respect to a position of the detected edge is detected and a dispersion value of 3×3 pixels is calculated with respect to a region at which the concentration is high. Then, if this dispersion value is less than a threshold value, the detection result of the character is inflated. This processing operation is similarly executed to a position of an edge paired with the previously detected edge so as to inflate the interior of the character. The inflation processing operations thus executed result in an output of “1” relative to a character region and an output of “0” relative to a non-character region.

In addition, the edge detection is executed by using Sobel filters but the present invention should not be limited to Sobel filters. In spite of Soble filters, another edge detection method such as Laplacian filters may be used.

Next, the hue determining portion 222 will be described in detail. This hue determining portion 222 is adapted for calculating the hue/chroma based on RGB signals. Specifically, from the RGB signals, a hue signal calculating portion 251 and a chroma signal calculating portion 252 calculate the hue signal/chroma signal by using the following operation equations:
hue signal=tan⁻¹((R-G)/(G-B))×180/p
chroma signal=Max(|R-G|, |G-B|).

Here, the equation Max(|R-G|, |G-B|) outputs a larger one of two absolute values of (R-G) and (G-B) by comparison between their two absolute values. A determining portion 253 determines the hue based on the calculated color signal/chroma signal. Specifically, the calculated chroma signal is compared to a threshold value the and then executes the determination of “chromatic color” or “black (achromatic color)” based on the following determination conditions:

if chroma signal<thc, then it is black; and

if chroma signal=thc, then it is chromatic color.

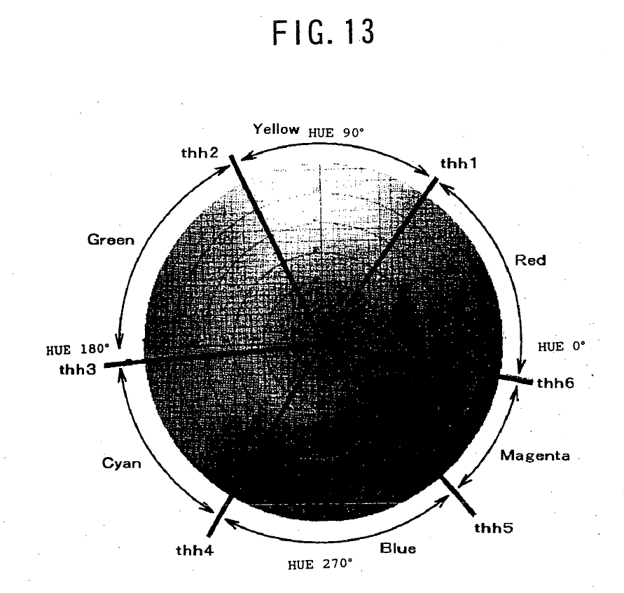

Then, if this determination indicates the achromatic color, a “Black hue” is outputted. Also, if this determination indicates the chromatic color, its hue is determined by using the hue signal. The hue signal can be expressed at an angle over a range between 0° and 360° as shown in FIG. 13. Thus, the hue is determined based on the hue signal expressible by an angle by using the following condition equations:
if thh6<hue signal=thh1, then it is Red;
if thh1<hue signal=thh2, then it is Yellow;
if thh2<hue signal=thh3, then it is Green;
if thh3<hue signal=thh4, then it is Cyan;
if thh4<hue signal=thh5, then it is Blue;
and
if thh5<hue signal=thh6, then it is Magenta.

It should be noted that each of “thh1” through “thh6” is a threshold value for allocating the hue signal to any one of hue regions.

From the determinations as above, a hue for each pixel can be determined. After the hue determination, “0” in the case of Black, “1” in the case of Red, “2” in the case of Yellow, “3” in the case of Green, “4” in the case of Cyan, “5” in the case of Blue, and “6” in the case of Magenta are outputted as the hue determination results.

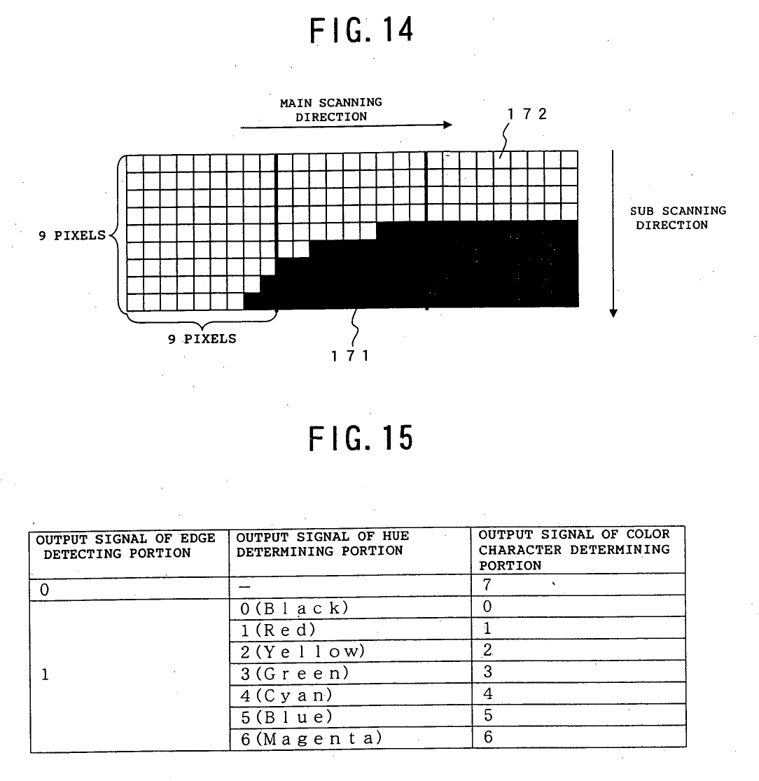

Next, the base color determining portion 223 will be described in detail. The base color determining portion 223 is comprised: a sample extracting portion 271; an edge pixel removing portion 272; and a base hue determining portion 273. The sample extracting portion 271 is adapted for performing a sampling by 9 pixels in a main scanning direction in a 9×9 pixel block as shown in FIG. 14.

After the sampling by a 9×9 pixel block, the edge removing portion 272 is adapted for removing edge pixels 171 (character pixels) existed in a 9×9 pixel block by using the edge detection result. The base hue determining portion 273 is adapted for counting how many pixels of respective hues exist in the base pixels 172 (corresponding to the peripheral region) and determining a hue having the maximum count value as the block hue.

Based on this hue determination, the base color is determined. The base color determination results are outputted as follows: “0” in the case of Black; “1” in the case of Red; “2” in the case of Yellow; “3” in the case of Green; “4” in the case of Cyan; “5” in the case of Blue; and “6” in the case of Magenta. If there exists no edge pixels in the 9×9 pixel block, it is determined as a picture region to output “7” as the base color determination result.

Next, the color character determining portion 224 will be described in detail. The color character determining portion 224 is configured to combine the edge detection result with the hue determination result to determine a color of the character region as shown in FIG. 10. More specifically, respective signals are outputted based on a table as shown in FIG. 15.

In FIG. 15, if an output signal of the edge detecting portion 221 is “0 (non-character)”, then “7” is outputted regardless of the output of the hue determining portion. If the output signal of the edge detecting portion 221 is “1”, then an outputted value is changed based on the output signal of the hue determining portion.

Next, the color category determining portion 225 will be described in detail. The color category determining portion 225 is adapted for synthesizing the color character determination result and the base color determination result to output a Dsc2 signal of 6 bits. Specifically, “0” through “6” of the base color determination results are allocated to its three highmost bits and “0” through “7” of the color character determination results are allocated to its three lowmost bits.

Next, the concentration correcting portion 212 will be described in detail. The concentration correcting portion 212 is adapted for switching concentration correcting tables from one to another based on the discrimination signal Dsc1. More specifically, the concentration correcting portion is adapted for switching concentration correcting tables from one to another depending on the Dsc1 signal being “7 (non-character)” or the other (character) by using the following operation equations.

Non-Character Operation Equations:
BKout=Table_PK[BK];
Cout=Table_PC[C];
Mout=Table_PM[M]; and
Yout=Table_PY[Y],

Character Operation Equations
BKout=Table_CK[BK];
Cout=Table_CC[C];
Mout=Table_CM[M]; and
Yout=Table_CY[Y].

Here, Table_PK, Table_PC, Table_PM, Table_PY are concentration correcting tables for non-character, one each for colors CMYBK, and Table_CK, Table_CC, Table_CM, Table_CY are concentration correcting tables for character, one each for colors CMYBK. Also, the BKout, Cout, Mout, and Yout are signals after correction, respectively. That is, if each of concentrations of respective colors functions as an input, the concentration correcting tables are each adapted for serving as a correction rule to obtain a monochromatic output relative to the corresponding color of its concentration.

Next, the filter processing portion 213 is adapted for switching the LPF and the HPF from each other based on the discrimination signal Dsc1. Specifically, depending on “7(non-character)” or the other (character) as the discrimination signal Dsc1, the LPF and the HPF are switched from each other.

The gradation processing portion 214 is adapted fro switching a screen having priority to gradation and a screen having priority to resolving power from each other.

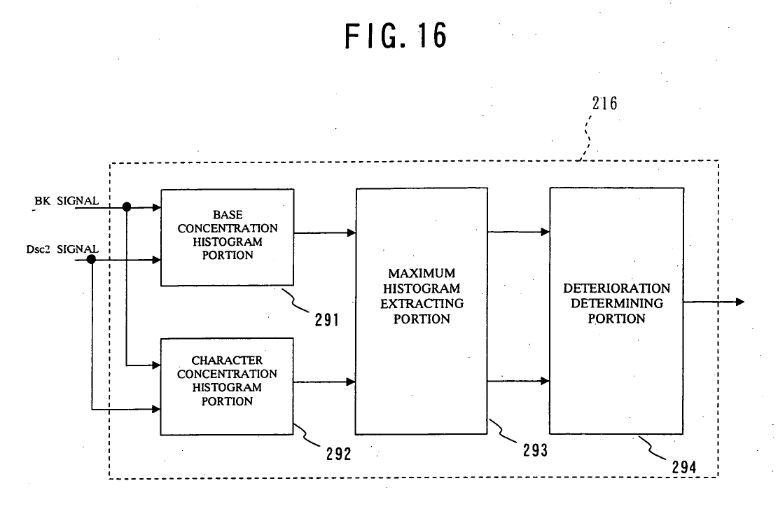

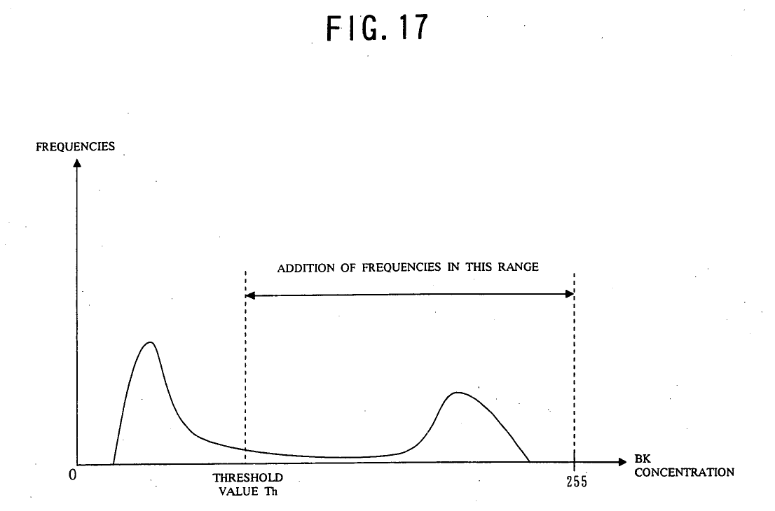

Next, the picture quality deterioration determining portion 216 will be described in detail. The picture quality deterioration determining portion 216 is comprised of: a base concentration histogram portion 291; a character concentration histogram portion 292; a maximum histogram extracting portion 293; and a deterioration determining portion 294 as shown in FIG. 16. The base concentration histogram portion (a peripheral region concentration histogram calculating portion) 291 is adapted for calculating a BK signal histogram for each the base color based on the discrimination signal Dsc2 (a peripheral region concentration histogram calculation step). Here, since the base hue determination result is allocated to three highmost bits of the Dsc2 signal, the histogram for each hue (Cyan, Magenta, Yellow, Black, Red, Green, and Blue) is created based on this hue determination result. That is, the base concentration histogram portion 291 is adapted for calculating the histogram representative of a relation between a color concentration for each hue and the number of pixels having the color concentration within all of pixels forming the peripheral region. However, if seven (“7”) is allocated to all of three highmost bits of the Dsc2 signal, it will not be added to the histogram.

The character concentration histogram portion. (a specific region concentration histogram calculating portion) 292 is adapted for calculating the concentration histogram for each hue with respect to pixels other than BK as the base hue (a specific region concentration histogram calculation step). That is, the character concentration histogram portion 292 is adapted for calculating the histogram representative of a relation between a color concentration for each hue and the number of pixels having the color concentration within all of pixels forming the specific region. The base concentration histogram and the character concentration histogram are calculated over all pixels on the original. In association with the base and character concentration histograms thus calculated over all pixels, the maximum histogram extracting portion 293 is adapted for extracting the maximum histograms from the respective concentration histograms. Here, each of the base and character concentration histograms is formed by adding up histogram frequencies for each hue having a concentration more than a predetermined threshold value (Th) (particularly within a predetermined concentration range).

The reason why the histograms are limited to those more than the predetermined threshold value is that the picture quality deterioration caused due to the image crush may be occurred when the base concentration is of high while a sufficient contrast is assured when the base concentration is of low. Also, it is possible to freely set the threshold value Th relative to each hue histogram. Thus, the maximum histogram extracting portion 293 can extract the maximum histogram by comparing addition results of frequencies of respective hues.

With respect to calculation of the histogram, the histogram is not created by using, as data, 256 gradations of 0-255 of the BK signal but may be created by using, as data, 32 gradations with three lowmost bits of the Dsc2 signal being rounded. Hence, it is possible to reduce a memory capacity expensed for the histogram.

The deterioration determining portion 294 to which the extracted base and character concentration histograms are inputted is adapted for counting pixels on an overlap of the character concentration histogram relative to the base concentration histogram and calculating a rate at which the character concentration histogram is common in concentration distribution to the base concentration histogram (i.e., a rate at which both of the histograms are overlapped one another). Subsequently, this rate is compared with a predetermined threshold value. If the rate is larger than the predetermined threshold value, then it is determined that the picture quality deterioration has been occurred, thereby outputting an Err signal of “1” (a deterioration determination step). However, if it is not determined the picture quality deterioration has been occurred, then the Err signal of “0” is outputted.

The Err signal is outputted to the system portion 217 that is adapted for performing an image output based on a value of the Err signal and then notifying an indication of the possibility of picture quality deterioration on the control panel (a notifying portion) 218 by stopping the image output. The notification may be performed by using sounds or voices.

More specifically, in the event that an overlapping rate between the histogram calculated from the specific region concentration histogram calculating portion and the histogram calculated from the peripheral region concentration histogram calculating portion is larger than the predetermined threshold value, the picture quality deterioration determining portion 216 determines the possibility of occurrence of picture quality deterioration to be high when an image is transformed into a monochromatic image. In other words, on the assumption that a rate of the number of pixels which partially form the specific region and have the same hue and color concentration as pixels forming the peripheral region relative to the number of pixels forming the peripheral region pixels is larger than a predetermined threshold value, the picture quality deterioration determining portion 216 determines the possibility of occurrence of picture quality deterioration to be high when an image is transformed into a monochromatic image.

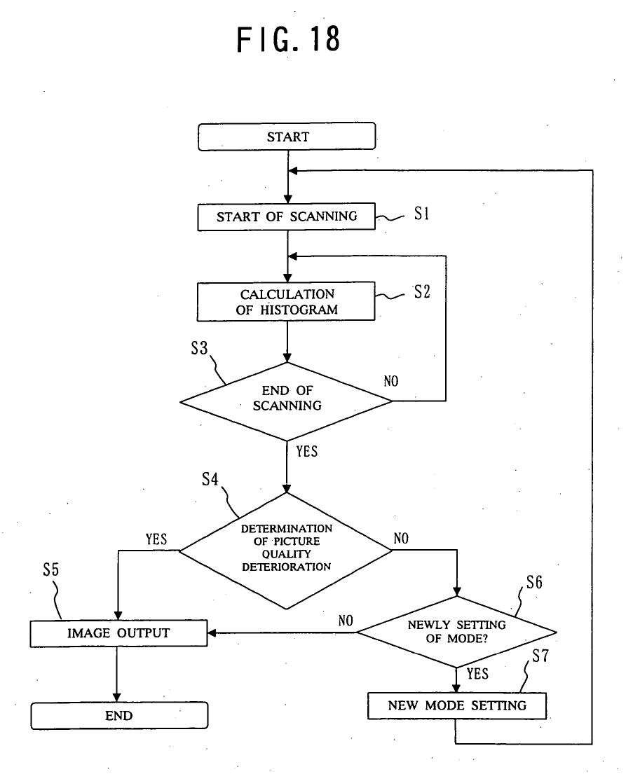

Next, an operation flow from a scan start to an image output will be described in detail. FIG. 18 is a flow chart for illustrating the operation flow from the scan start to the image output. After a picture quality mode (a concentration correction rule) for defining a pixel concentration correction upon transformation of an image into a monochromatic image is set on the control panel 218, a start key displayed on the control panel 218 is depressed by a user to start a reading of original (S1). With the start of reading the original, the original placed on the document glass is read by scanning the carriage in the sub scanning direction. The base concentration histogram portion 291 and the character concentration histogram portion 292 calculate histograms for image data of the read original, respectively (S2).

When the carriage reaches a predetermined position in the sub scanning direction, a processing operation for reading the image is ended (S3). After the processing operation for reading the image has been ended, the deterioration determining portion 294 determines whether a picture quality deterioration is occurred based on the histograms calculated in the above-mentioned step (S2). The determination regarding the picture quality deterioration results in a “non-occurrence of deterioration”, thereby performing an image output (S5). However, the determination regarding the picture quality deterioration results in an “occurrence of deterioration”, thereby notifying the user of the picture quality deterioration by displaying the information on the control panel 218 (a notification step).

At the time when that notification is executed, the user is prompted on the control panel 218 to select whether the read image intact should be outputted or the picture quality mode should newly be set (S6). In addition to selection of the read image output and the newly setting of picture quality mode, at least one preset picture quality mode candidate serving as another picture quality mode suitable for suppressing the picture quality deterioration may be listed on the control panel 218 so that the user is requested on the control panel 218 to change over to any of the above-mentioned candidates or options (a change-over request step).

If the image output has been selected (S6: No), the data which have already been finished up to the gradation processing operation is outputted to the engine to perform the printing. If the user newly selects one mode (S6: Yes), a newly setting (S7) is performed in response to the mode for selecting a correction table in the concentration correcting portion 212 to start the scanning again (S1).

Also, when the determination regarding the picture quality deterioration results in an “occurrence of deterioration”, it is possible to automatically change over from the picture quality mode to another picture quality mode instead of the step (S6) as mentioned above. This automatically changing operation may be performed, for example, by the system portion/engine portion (an automatic changing-over portion) 217. Further, when the picture quality mode is automatically changed, it is desired to notify the user of the automatic changing-over of the picture quality mode by displaying the information on the control panel 218 (the notification step).

Furthermore, when the determination regarding the picture quality deterioration results in an “occurrence of deterioration”, it is possible to automatically stop a predetermined processing operation (a duplication operation, an image output operation and the like) of the image processing apparatus instead of the step (S6) as mentioned above. At this time, the predetermined processing operation may be stopped, for example, by the system portion/engine portion 217 (a stoppage step). In addition, in the event that the predetermined processing operation is automatically stopped, it is desired to notify the user of the automatic stoppage of the predetermined processing operation by displaying the information on the control panel 218 (the notification step).

Also, when the determination regarding the picture quality deterioration results in an “occurrence of deterioration” and the predetermined processing operation is stopped, it is possible to list on the control panel 218 at least one preset picture quality mode candidate serving as another picture quality mode suitable for suppressing the picture quality deterioration so that the user is requested on the control panel 218 to change over to any of the above-mentioned candidate options (the change-over request step) In this manner, when the picture quality mode has been changed, it is preferable to recommence the stopped predetermined processing operation (a recommencement step).

Also, when the determination regarding the picture quality deterioration results in an “occurrence of deterioration” and the predetermined processing operation is stopped, it is possible to automatically change over the picture quality mode to another picture quality mode (an automatic change-over step) so that further information can be re-acquired in the hue information acquisition step and the concentration information acquisition step (an information re-acquisition step).

### A Second Embodiment

In the first embodiment as described above, the user newly sets the mode upon occurrence of the picture quality deterioration so as to commence a re-scanning operation for performing the image output. In this second embodiment, such re-scanning operation will not be performed even when the picture quality deterioration is occurred.

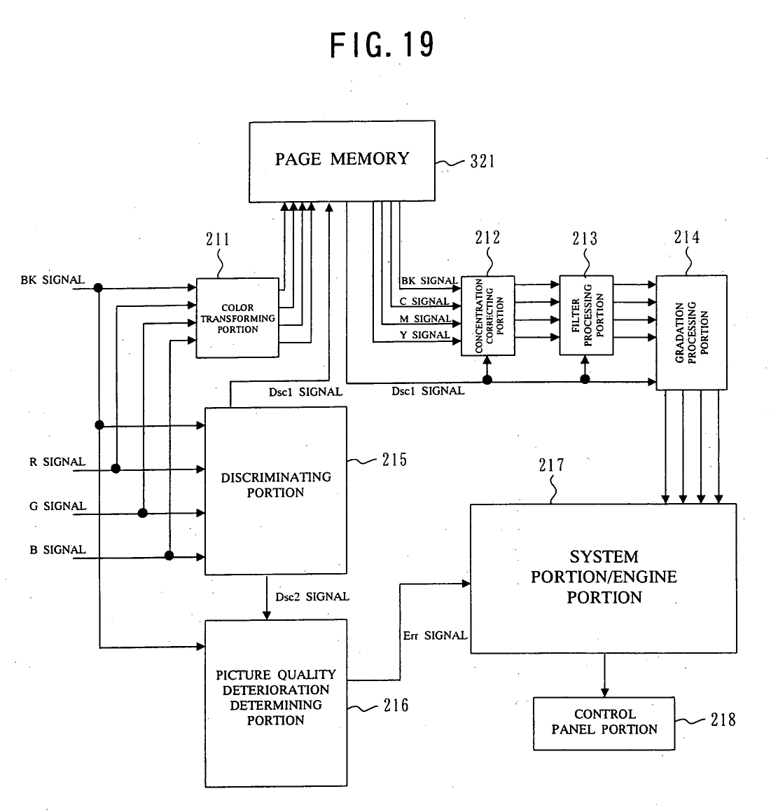

FIG. 19 is a schematic diagram illustrating a detailed configuration of the image processing portion wherein like parts similar to those in the first embodiment as described above are labeled with corresponding numerals and therefore their explanations are omitted. In this configuration, a page memory 321 capable of storing a page of image data is newly added to the posterior part of the color transforming portion 211. The RGB signals and BK signal outputted in response to a scanning operation are transformed in concentration by the color transforming portion 211 and stored in the page memory 321. At the same time, the Dsc1 signal outputted from the discriminating portion 215 is also stored in the page memory 321. At the time when a scanning over one page has been finished, a page of image data is being stored in the page memory 321 (a previously acquired image). Here, if a picture quality deterioration is anticipated by the picture quality deterioration determining portion 216 after the scanning, a mode selection will newly be performed by the user. Then, the user sets a concentration correction table corresponding to the mode selected for the concentration correcting portion 212. After setting of the concentration correction table, image data is sequentially read from the page memory and are sequentially processed in the concentration correcting portion 212, the filter processing portion 213 and the gradation processing portion 214. Finally, the image data thus processed is outputted to the system portion/the engine portion 217 for the image formation. In this manner, this embodiment is configured to re-acquire the hue information and the hue concentration information from the image information of the previously acquired image (an information re-acquisition step).

As described above, it is possible to perform the image output by using the page memory without newly scanning according to the second embodiment. Also, the second embodiment is configured to make the user newly perform the mode selection, but can be configured to, based on the determination result of the picture quality deterioration determining portion 216, automatically select the concentration correction table by which no crush is occurred.

In addition, the second embodiment is configured to store the concentration correction table in the apparatus, but should not be limited to such a configuration. For example, the second embodiment can be configured to store the concentration correction table in a storage region of an external equipment which is communicatively coupled to the apparatus.

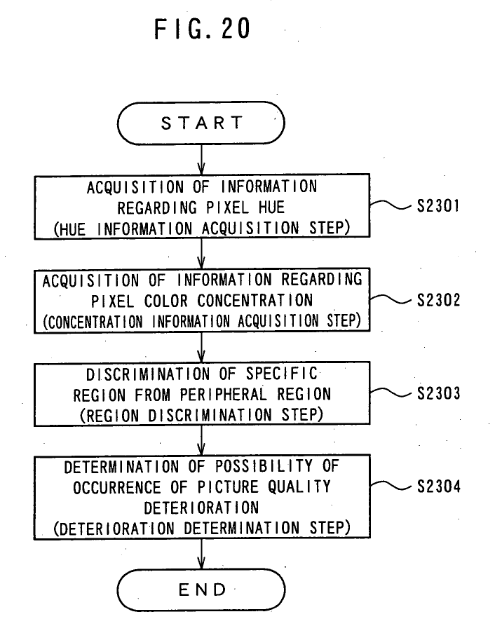

Next, an overall processing flow of the image processing apparatus according to the second embodiment will be described in detail with reference to a flow chart as shown in FIG. 20.

Firstly, hue information regarding pixels forming an image is acquired (a hue information acquisition step) (S2301).

Subsequently, hue concentration information regarding pixels forming the image is acquired (a concentration information acquisition step) (S2302).

Based on the hue information and the hue concentration information thus acquired, a specific region on the image and a peripheral region adjacent to the specific region are discriminated (a region discrimination step) (S2303)

A rate of—the number of pixels which partially form the specific region and have the same hue and color concentration as pixels forming the peripheral region—relative to—the number of pixels forming the peripheral region pixels—is larger than a predetermined threshold value, the picture quality deterioration determining portion 216 determines the possibility of occurrence of picture quality deterioration to be high when an image is transformed into a monochromatic image (a deterioration determination step) (S2304).

The above mentioned steps (S2301-S2304) can be realized by causing a computer to execute an image producing program stored in a storage region of the image processing apparatus.

Incidentally, in this embodiment as described above, the function to embody the present invent ion has previously been stored in the apparatus. However, it is possible to download a similar function via a network to the apparatus or to install a storage medium storing therein the similar function in the apparatus. As such a storage medium, it is possible to adopt any form of a storage medium which is capable of storing a program or readable by the apparatus, such as CD-ROM or the like. Of course, the function obtainable by the previous installation or the download is cooperated with an OS in the apparatus so as to exercise that function.

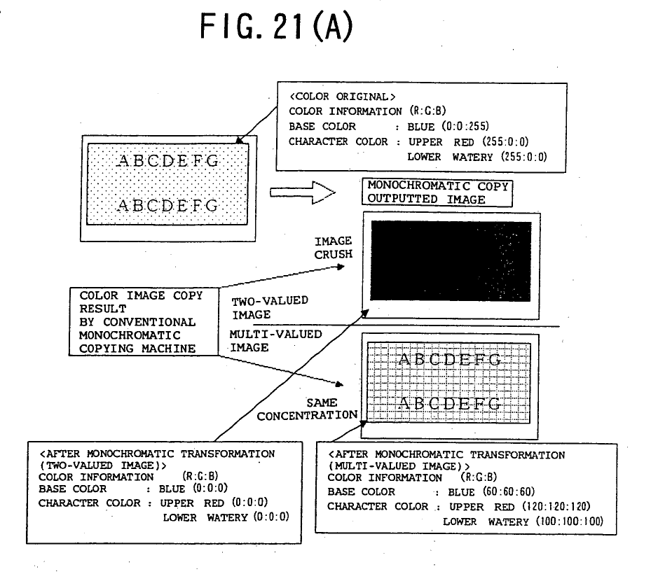

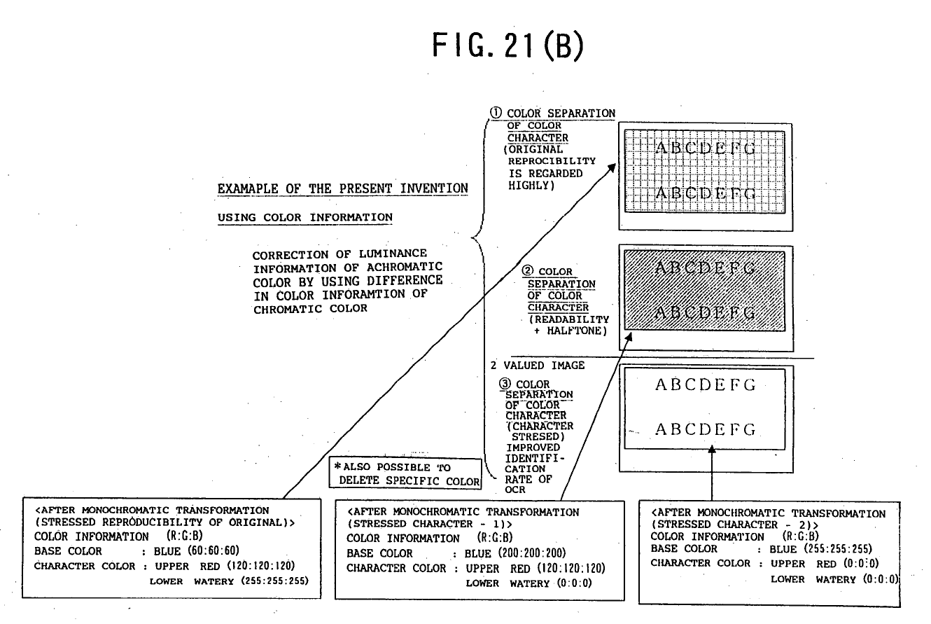

FIGS. 21(A) and 21(B) show a specific example of effective actions at the time of copying operation according to the present invention.

In the event that a color original ORG has a base of blue color (color information R: 0, G: 0, B: 255), upper-row characters of red color (color information R: 255, G: 0, B: 0), and lower-row characters of watery color (color information R: 50, G: 100, B: 255), dataconversion processing, concentration transformation processing and the like are performed for the monochromatic copying to output a binarized image. Depending on threshold values for binarization of an image, all of colors of the base, upper-row and lower-row characters may reach 255 as the highest concentration data, as a result of which the information of the color original ORG may be black wholly with the lack of character information. In the event that any suitable processing is performed for generating multi-value output to reproduce a halftone, the concentration data of the base, upper-row characters and lower-row characters are 80:50:45, as a result of which there still exists a difference in concentration (contrast) between the base and the characters but the concentration data values of the upper-row characters and lower-row characters may be approximate to each other, thereby raising a problem where the upper-row characters and lower-row characters can be printed at the same concentration.

In the present invention, if a reproducibility of the color original ORG in which a printing is performed to be propositional to the color information of the color original is regarded highly, it is possible to provide differences in concentration among the base, upper-row and lower-row characters for example by setting the base concentration data to 80, the upper-row character data to 50, the lower-row character data to 0, respectively, and then obtain a printing result where differences in the color information thereof are take into consideration.

Also, if written character information is regarded highly in comparison with the base, it is possible to provide differences in concentration among the base, upper-row and lower-row characters for example by setting the base concentration data to 40, the upper-row character data to 80, the lower-row character data to 255, respectively, and then obtain a printing result where differences in the color information thereof are take into consideration and the written character information is emphasized.

Further, if the base color is deleted and only the character color is emphasized, it is possible to obtain a printing result where only the character information is emphasized by setting the base concentration data to 0, the upper-row character data to 255, the lower-row character data to 255, respectively.

On the other hand, it is possible to limit an object to be subjected to the correction processing of luminance in the monochromatic correcting portion to either of the base, upper-row character and lower-row character, or any color (a specified color) based on an operation input by the user externally or from the control panel. This enables the monochromatic correction having a high degree of freedom to be performed.

In the description as above, the highest concentration is set to 255 but it is possible to set to 1023 in the case of 10-bit data. Also, as a light emitting amount or a light emitting period of time of the semiconductor laser becomes bigger, it becomes possible to reproduce black color as the high concentration. Therefore, in the description as above, a high concentration image can be obtain by bigger concentration data. However, needless to say, it is possible to obtain a higher concentration as the concentration data becomes smaller.

According to the second embodiment, it is possible to previously anticipate the occurrence of picture quality deterioration by using all of the RGBK signals. The present invention can be applicable to a network scanner connected via a network to any computers. In that case, a notification to the user is performed by the control panel or a personal computer communicatively coupled to the image processing apparatus.

Also, according to the second embodiment, it is possible to anticipate the picture quality deterioration relative to an image read by the image reading apparatus and to notify the user of the occurrence of picture quality deterioration. Hence, it is possible to provide a high picture quality image to the user without any output of a failed duplicated image having the picture quality deterioration. Further, it becomes unnecessary to newly scan an original by addition of the page memory, thereby enabling an image to be newly outputted with speeding-up thereof.

As described in detail, it is possible to provide a technology by which a high picture quality monochromatic image can be obtained from a color image original according to the present invention.

What is claimed is:

1. An image processing apparatus, comprising:
a hue information acquiring portion adapted for acquiring hue information regarding pixels forming an image;
a concentration information acquiring portion adapted for acquiring hue concentration information regarding pixels forming the image; and
a deterioration determining portion,
wherein, in the event that a rate of the number of pixels having the same hue and color concentration as those of pixels forming the image is higher than a predetermined threshold value based on the hue information and the hue concentration information thus acquired, said deterioration determining portion is adapted for determining the possibility of occurrence of picture quality deterioration to be high when the image is transformed into a monochromatic image.

2. An image processing apparatus, comprising:
a hue information acquiring portion adapted for acquiring hue information regarding pixels forming an image;
a concentration information acquiring portion adapted for acquiring hue concentration information regarding pixels forming the image;
based on the hue information and the hue concentration information thus acquired, a histogram calculating portion adapted for calculating a histogram representative of a relation between a color concentration for each hue and the number of pixels having said color concentration; and
a deterioration determining portion,
wherein, in the event that a rate at which histograms calculated for hues by said histogram calculating portion are overlapped one another is higher than a predetermined threshold value based on the hue information and the hue concentration information thus acquired, said deterioration determining portion is adapted for determining the possibility of occurrence of picture quality deterioration to be high when the image is transformed into a monochromatic image.

3. The image processing apparatus according to claim 2, wherein said deterioration determining portion is adapted for calculating within a predetermined concentration range a rate at which histograms calculated by said specific region concentration histogram calculating portion and histograms calculating by said peripheral region concentration histogram calculating portion are overlapped one another.

4. The image processing apparatus according to claim 1, further comprising a notifying portion adapted for notifying a user of the fact that the possibility of occurrence of picture quality deterioration has been determined to be high in said deterioration determining portion.

5. The image processing apparatus according to claim 1, further comprising an automatic changing-over portion adapted for changing over a pixel concentration correction upon transformation of the image into a monochromatic image when the possibility of occurrence of picture quality deterioration has been determined to be high in said deterioration determining portion.

6. An image processing program that is executed by a computer, comprising the steps of:
acquiring hue information regarding pixels forming an image;
acquiring hue concentration information regarding pixels forming the image; and
in the event that a rate of the number of pixels having the same hue and color concentration as those of pixels forming the image is higher than a predetermined threshold value based on the hue information and the hue concentration information thus acquired, determining the possibility of occurrence of picture quality deterioration to be high when the image is transformed into a monochromatic image.

7. An image processing program that is executed by a computer, comprising the steps of:
acquiring hue information regarding pixels forming an image;
acquiring hue concentration information regarding pixels forming the image;
based on the hue information and the hue concentration information thus acquired, calculating a histogram representative of a relation between a color concentration for each hue and the number of pixels having said color concentration; and
in the event that a rate at which histograms calculated for hues by said histogram calculation step are overlapped one another is higher than a predetermined threshold value, determining the possibility of occurrence of picture quality deterioration to be high when the image is transformed into a monochromatic image.

8. The image processing program according to claim 7, wherein said deterioration determination step is adapted for calculating within a predetermined concentration range a rate at which histograms calculated by said specific region concentration histogram calculating portion and histograms calculating by said peripheral region concentration histogram calculating portion are overlapped one another.

9. The image processing program according to claim 7, wherein histograms for respective hues calculated in said specific region concentration histogram calculation step and said peripheral region concentration histogram calculation step are calculated in relation to at least one of Cyan, Magenta, Yellow, Black, Red, Green, and Blue.

10. The image processing program according to claim 6, further comprising a notification step adapted for notifying a user of the fact that the possibility of occurrence of picture quality deterioration has been determined to be high in said deterioration determination step.

11. The image processing program according to claim 10, wherein said notification is executed in said notification step by a picture display.

12. The image processing program according to claim 10, wherein said notification is executed in said notification step by sounds.

13. The image processing program according to claim 10, further comprising a change-over request step adapted for requesting the user to change over a concentration correction for defining a pixel concentration correction upon transformation of the image into a monochromatic image when the possibility of occurrence of picture quality deterioration has been determined to be high in said deterioration determination step.

14. The image processing program according to claim 10, further comprising an automatic change-over step adapted for changing over a concentration correction for defining a pixel concentration correction upon transformation of the image into a monochromatic image when the possibility of occurrence of picture quality deterioration has been determined to be high in said deterioration determination step.

15. The image processing program according to claim 14, further comprising a notification step adapted for notifying the user of the fact that said concentration correction is changed over in said automatic change-over step.

16. The image processing program according to claim 6, further comprising a stoppage step adapted for stopping a predetermined processing operation when the possibility of occurrence of picture quality deterioration has been determined to be high in said deterioration determination step.

17. The image processing program according to claim 16, further comprising:
a change-over request step adapted for requesting the user to change over a concentration correction for defining a pixel concentration correction upon transformation of the image into a monochromatic image when the predetermined processing operation has been stopped in said stoppage step; and
a recommencement step adapted for recommencing said stopped predetermined processing operation when said concentration correction has been changed over.

18. The image processing program according to claim 16, further comprising:
an automatic change-over step adapted for changing over a concentration correction for defining a pixel concentration correction upon transformation of the image into a monochromatic image when the predetermined processing operation has been stopped in said stoppage step; and
a recommencement step adapted for recommencing said stopped predetermined processing operation when said concentration correction has been changed over.

19. The image processing program according to claim 16, further comprising:
an automatic change-over step adapted for changing over a concentration correction for defining a pixel concentration correction upon transformation of the image into a monochromatic image when the predetermined processing operation has been stopped in said stoppage step; and
an information reacquisition step adapted for recommencing the information acquisition in said hue information acquisition step and said concentration information acquisition step.

20. The image processing program according to claim 19, wherein said information reacquisition step adapted for reacquiring said information from the image information of the previously acquired image.
